(19) United States
(12) Patent Application Publication
(10) Pub. No.: US 2016/0099949 A1
(43) Pub. Date: Apr. 7, 2016

(54) Systems and Methods for Document-Level Access Control in a Contextual Collaboration Framework

(71) Applicant: Clique Intelligence, Redwood City, CA (US)

(72) Inventors: Art Leondires, Redwood City, CA (US); Alan McLeod, Redwood City, CA (US); Sanjay Lobo, Pottsboro, TX (US)

(21) Appl. No.: 14/873,720

(22) Filed: Oct. 2, 2015

Related U.S. Application Data
(60) Provisional application No. 62/059,789, filed on Oct. 3, 2014.
(60) Provisional application No. 62/136,262, filed on Mar. 20, 2015.

(51) Int. Cl. H04L 29/06; G06F 21/62

(52) U.S. Cl. CPC H04L 63/105; G06F 21/62; H04L 65/403

(57) ABSTRACT

Systems and methods are provided for managing contextual collaborations. User data corresponding to a plurality of users is stored. The plurality of users include at least a first and second user. A first computing device associated with the first user receives a first access-level designation for a first document included in a first contextual collaboration. The first access-level designation is stored in association with the first user and the first document. A request to access the first document included in the first contextual collaboration is received from a second computing device associated with a second user. Based on the stored first access-level designation, it is determined whether to provide access to the first document by the second computing device associated with the second user. A response is transmitted to the second computing device associated with the second user, the response granting or denying access to the first document.

### CROSS REFERENCE TO RELATED APPLICATION

The present application claims the benefit of and priority to U.S. Provisional Application No. 62/059,789, filed on Oct. 3, 2014 and titled “SYSTEMS AND METHODS FOR DOCUMENT-LEVEL ACCESS CONTROL IN A CONTEXTUAL COLLABORATION FRAMEWORK”; and U.S. Provisional Application No. 62/136,262, filed Mar. 20, 2015 and titled “SYSTEMS AND METHODS FOR PROVIDING ACCESS-CONTROL IN CONTEXTUAL COLLABORATIONS,” the entire contents of which are hereby incorporated by reference herein.

The present application is related to U.S. Provisional Application No. 62/059,772, filed on Oct. 3, 2014 and titled “CONTEXTUAL PRESENCE SYSTEMS AND METHODS”; and U.S. Provisional Application No. 62/136,270, filed on Mar. 20, 2015, and titled “SYSTEMS AND METHODS FOR PROVIDING CONTEXTUAL PRESENCE”; and International Application No. PCT/US14/59154, filed on Oct. 3, 2014, and titled “SYSTEMS AND METHODS FOR ENTERPRISE MANAGEMENT USING CONTEXTUAL GRAPHS,” the entire contents of which are hereby incorporated by reference herein.

### FIELD OF THE INVENTION

The present invention generally relates to contextual collaborations. More particularly, the present invention relates to systems and methods for providing access-control in contextual collaborations.

### BACKGROUND

The number of interconnected computing devices and people continues to increase globally. Some estimates indicate that as many as fifty or even seventy five billion devices may be interconnected by the year 2020. Interconnectivity has allowed for the expansion of computer-supported collaboration among groups of people and entities such as enterprises, organizations, companies, schools, governments, communities, and the like.

Managing such collaborations, including the vast amounts of data, users and devices associated with those collaborations, has resulted in the development of systems, such as enterprise systems, that provide the necessary interconnectivity to communicate and utilize data in a collective manner. Enterprise systems are frequently used in accounting, manufacturing, order processing, supply chain management, project managements, customer relationship management, self-service interfaces, and the like.

Entities, by employing such systems (e.g., enterprise systems), allow users anywhere in the world to work collaboratively towards common goals, for example, via contextual collaborations. Contextual collaboration refers to the concept of grouping and sharing resources among users and/or devices to achieve a collective objective, such as a project, lifecycle, process, and the like. The grouping of resources in contextual collaborations is performed in a structured and organized manner, so as to enable more efficient and effective cooperation. Some of the resources grouped and shared via contextual collaborations include tools (e.g., services), documents, discussions, files, data, permissions, users, priorities, tasks, statuses, and the like. Contextual collaborations are described in more detail in U.S. Provisional Patent Application Nos. 62/059,772 and 62/059,789, respectively titled “CONTEXTUAL PRESENCE SYSTEMS AND METHODS” and “SYSTEMS AND METHODS FOR DOCUMENT-LEVEL ACCESS CONTROL IN A CONTEXTUAL COLLABORATION FRAMEWORK,” and filed on Oct. 3, 2014. The entire contents of these applications are hereby incorporated herein by reference in their entireties.

Traditionally, users of a contextual collaboration, in an effort to work cooperatively towards the completion of a goal, have openly shared resources that make up the contextual collaboration. That is, documents and the like which form the contextual collaboration, have been readily available to users of the contextual collaboration, regardless of the users' roles, locations, and the like. In fact, contextual collaborations created and commonly used within a single enterprise are often shared with members outside of the enterprise. In this manner, resources, and the information included therein, becomes accessible both to members of the enterprise that should not be privy to the information, as well as external members who should either not be privy to the information or be subject to provisions of confidentiality agreements.

Given the foregoing, it would be beneficial to provide systems and methods for providing access-control in contextual collaborations. It would also be beneficial to restrict access to resources, documents, context lists, contextual collaborations, workspaces and the like. It would also be beneficial to provide multiple levels of access that can be assigned to the resources, documents, and the like.

### SUMMARY

The disclosed technology provides a system for control of access to electronic documents for users associated with, and who are working within, one or more collaborative workspaces of a context-based collaboration system, e.g., implemented over a computer network. The access system allows for protected intra- and inter-organizational sharing of resources while promoting engagement and collaboration among users within and among organizations through such sharing.

To allow for secured access of a document by users within the same domain (e.g., a company or organization) who own/originate the document, as well as by designated users external to such domain, the access control information is configured to follow the document within the contextual collaboration system. That is, the permissions information are embedded within the document (e.g., within the document header or the metadata of the document). As such, the document access controls are not simply limited to a separate location within the computer file system.

Moreover, to promote collaboration and ease-of-use, the disclosed technology provides access level and permission structures with varying levels of access for individuals, and group of users, that are intuitive and quick to assign and manage (e.g., adding, removing, and/or changing existing designations) within the collaborative workspaces of a context-based collaboration system.

Independent to, or in conjunction with, the above features, the disclosed technology provides document control features that improve the workflow of documents within a given organization by enforcing compliance with organization policy for documents, particularly, the dissemination of confidential documents.

In one aspect, the present disclosure describes, within a collaborative system for creating and managing a collection of contextual collaborations for users (e.g., associated with an enterprise), a method for granting and/or restricting access to documents associated with one or more contextual collaborations. The method includes determining, via a processor of a computing device, for each contextual collaboration of a collection of contextual collaborations associated with a user, an access level designation for each document associated with the contextual collaboration. In some embodiments, the access level designation is selectable (e.g., by an owner/originator of the document and/or contextual collaboration) from a pre-defined set of access level designations (e.g., named user/private, domain user/restricted, NDA/confidential, and public/default). The method further includes causing, via the processor, the collection of contextual collaborations to be graphically rendered on a display of a computing device associated with the user. The method further includes causing, via the processor, the graphical rendering of one or more icons representing one or more documents to which the user has access according to the access level designation associated with the corresponding document(s) upon access by the user of a workspace associated with the selected contextual collaboration.

In some embodiments, the method further includes causing, via the processor, the graphical rendering of the access level designation associated with the contextual collaboration, the designation being inherited from the access level designation of each of the one or more documents associated therewith.

In some embodiments, the pre-defined set of access level designations includes a first user-access designation (e.g., a named user/private access designation). The first user-access designation allows the document to be viewed and accessed by: (i) a document owner (e.g., a user that has added the given document to the contextual collaboration) and (ii) a named user (e.g., a user designated by the document owner to have access to the document for the contextual collaboration).

In some embodiments, the set of pre-defined access levels comprises a second user-access designation (e.g., a domain user/restricted access designation). The second user-access designation allows the document to be viewed and accessed by: (i) a document owner (e.g., a user that has added the given document to the contextual collaboration) and (ii) a domain user (e.g., a user who is a member of a specified domain designated by the document owner to have access to the document, where the domain is based, e.g., on an organization identifier, an email domain, or a website domain, and wherein the user is, e.g., an internal or external member of the domain associated with the document owner).

In some embodiments, the set of pre-defined access levels includes a third user-access designation (e.g., a non-disclosure-agreement/confidential user-access designation). The third user-access designation allows the document to be viewed and accessed by: (i) a document owner (e.g., a user that has added the given document to the collaborative system) and (ii) a domain user (e.g., a user who is a member of a specified domain designated by the document owner to have access to the given document, where the domain is based, e.g., on an organization identifier, an email domain, or a website domain, and where the user is, e.g., an internal or external member of the domain associated with the document owner). The third user-access designation, in some embodiments, causes the system to prompt the document owner, when adding the given document to the contextual collaboration, to affirm that each user associated with the given contextual collaboration is subject to an agreement (e.g., a non-disclosure or confidentiality agreement) to have access to the given document.

In some embodiments, the third user-access designation causes the system to determine whether the contextual collaboration to which the document is being added has any users outside the domain associated with the document owner. The system causes the document user to be prompted, when adding the given document to the contextual collaboration, based on the determination, to affirm that each user outside the domain of the document owner and associated with the collaborative workspace is subject to an agreement (e.g., a NDA or confidentiality agreement) (e.g., wherein the agreement controls access to the given document) (e.g., and wherein the prompt provides an instructional message to the user).

In some embodiments, the method further includes receiving, via the processor, a request from a user to add, to a given contextual collaboration, a document designated with a non-disclosure-agreement user-access designation; determining, via the processor, whether the given contextual collaboration includes one or more users outside the domain of the user; and causing, via the processor, a notification to be made to the user, the notification graphically indicating that the contextual collaboration includes at least one user outside the domain of the user (and, e.g., further prompting the user to acknowledge that a non-disclosure-agreement has been signed with an organization associated with the at least one user to whom the given collaborative workspace is associated).

In some embodiments, the set of pre-defined access levels includes a fourth user-access designation (e.g., a public/default access designation). The fourth user-access designation allows the document to be viewed and accessed by: (i) a document owner (e.g., a user that has added the document to the contextual collaboration) and (ii) all users within a domain associated with the document owner. In some embodiments, the fourth user-access designation allows the document to be viewed and accessed by the document owner and all users within a contextual collaboration to which the given document is associated.

In some embodiments, the access level designation for a given document is selectable from one and only one of the pre-defined set of access level designations.

In some embodiments, the access level designation of a document associated with a contextual collaboration is embedded within the document (e.g., within the document header or the metadata of the document).

In another aspect, the present disclosure describes a collaborative system for creating and managing a collection of contextual collaborations for users (e.g., associated with an enterprise). The system includes a processor and a memory, the memory storing instruction that, when executed by the processor, cause the processor to determine, for each contextual collaboration of a collection of contextual collaborations associated with a user, an access level designation for each document associated with the contextual collaboration, wherein the access level designation is selectable (e.g., by an owner/originator of the document and/or contextual collaboration) from a pre-defined set of access level designations (e.g., named user/private, domain user/restricted, NDA/confidential, and public/default). The instructions, when executed, further cause the processor to cause the collection of contextual collaborations to be graphically rendered on a display of a computing device associated with the user. The instructions, when executed, further cause the processor to cause the graphical rendering of one or more icons representing one or more documents to which the user has access according to the access level designation associated with the corresponding document(s) upon access by the user of a workspace associated with the selected contextual collaboration.

In some embodiments, the instructions, when executed by the processor, further cause the graphical rendering of the access level designation associated with the contextual collaboration, the designation being inherited from the access level designation of each of the one or more documents associated therewith.

In some embodiments, the pre-defined set of access level designations includes a first user-access designation (e.g., a named user/private access designation). The first user-access designation allows the document to be viewed and accessed by: (i) a document owner (e.g., a user that has added the given document to the contextual collaboration) and (ii) a named user (e.g., a user designated by the document owner to have access to the document for the contextual collaboration).

In some embodiments, the set of pre-defined access levels includes a second user-access designation (e.g., a domain user/restricted access designation). The second user-access designation allows the document to be viewed and accessed by: (i) a document owner (e.g., a user that has added the given document to the contextual collaboration) and (ii) a domain user (e.g., a user who is a member of a specified domain designated by the document owner to have access to the document, where the domain is based, e.g., on an organization identifier, an email domain, or a website domain, and wherein the user is, e.g., an internal or external member of the domain associated with the document owner).

In some embodiments, the set of pre-defined access levels includes a third user-access designation (e.g., a non-disclosure-agreement/confidential user-access designation). The third user-access designation allows the document to be viewed and accessed by: (i) a document owner (e.g., a user that has added the given document to the collaborative system) and (ii) a domain user (e.g., a user who is a member of a specified domain designated by the document owner to have access to the given document, where the domain is based, e.g., on an organization identifier, an email domain, or a website domain, and where the user is, e.g., an internal or external member of the domain associated with the document owner). The third user-access designation, in some embodiments, causes the system to prompt the document owner, when adding the given document to the contextual collaboration, to affirm that each user associated with the given contextual collaboration is subject to an agreement (e.g., a non-disclosure or confidentiality agreement) to have access to the given document.

In some embodiments, the third user-access designation causes the system to determine whether the contextual collaboration to which the document is being added has any users outside the domain associated with the document owner. The system causes the document user to be prompted, when adding the given document to the contextual collaboration, based on the determination, to affirm that each user outside the domain of the document owner and associated with the collaborative workspace is subject to an agreement (e.g., a NDA or confidentiality agreement) (e.g., wherein the agreement controls access to the given document) (e.g., and wherein the prompt provides an instructional message to the user).

In some embodiments, the instructions, when executed by the processor, cause the processor to receive a request from a user to add, to a given contextual collaboration, a document designated with a non-disclosure-agreement user-access designation; to determine whether the given contextual collaboration includes one or more users outside the domain of the user; and to cause a notification to be made to the user, the notification graphically indicating that the contextual collaboration includes at least one user outside the domain of the user (and, e.g., further prompting the user to acknowledge that a non-disclosure-agreement has been signed with an organization associated with the at least one user to whom the given collaborative workspace is associated).

In some embodiments, the set of pre-defined access levels comprises a fourth user-access designation (e.g., a public/default access designation). The fourth user-access designation allows the document to be viewed and accessed by: (i) a document owner (e.g., a user that has added the document to the contextual collaboration) and (ii) all users within a domain associated with the document owner.

In some embodiments, the access level designation for a given document is selectable from one and only one of the pre-defined set of access level designations.

In some embodiments, the access level designation of a document associated with a contextual collaboration is embedded within the document (e.g., within the document header or the metadata of the document).

### BRIEF DESCRIPTION OF THE DRAWINGS

The foregoing and other objects, aspects, features, and advantages of the present disclosure will become more apparent and better understood by referring to the following description taken in conjunction with the following drawings.

FIG. 1 is a screenshot of a graphical user interface for displaying a context list of contextual collaborations, in accordance with an exemplary embodiment.

FIG. 2 is a screenshot of a graphical user interface for displaying a contextual collaboration, in accordance with an exemplary embodiment.

FIGS. 3A and 3B are screenshots of a graphical user interface for displaying a contextual collaboration workspace, in accordance with an exemplary embodiment.

FIG. 4 is a screenshot of a graphical user interface for displaying a contextual collaboration workspace, in accordance with an exemplary embodiment.

FIG. 5 is a screenshot of a dialogue box prompt for managing external participants, in accordance with an exemplary embodiment.

FIG. 6 is a screenshot of a dialogue box prompt for managing external participants, in accordance with an exemplary embodiment.

FIG. 7 is a screenshot of a dialogue box for confirming confidentiality permissions, in accordance with an exemplary embodiment.

FIG. 8 is a flowchart illustrating a method for managing access to documents associated with contextual collaborations, in accordance with an exemplary embodiment.

FIG. 9 is a block diagram of a system for enterprise management using contextual collaborations, in accordance with an exemplary embodiment.

FIG. 10 is a block diagram that illustrates a system for enterprise management using contextual collaborations, in accordance with an exemplary embodiment.

FIG. 11 shows a block diagram of an exemplary cloud computing environment.

FIG. 12 is a block diagram of a computing device and a mobile computing device.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

The example embodiments presented herein are directed to systems and methods for providing access-control in contextual collaborations. More specifically, the example embodiments described herein provide controlling of access to resources (e.g., documents) for and by users associated with, and who are working within, one or more collaborative workspaces. The described embodiments provide for protection of intra- and inter-organizational sharing of resources, while promoting engagement and collaboration among users within and among organizations.

Contextual collaborations (e.g., contextual graphs) relate resources that occur in business workflows by providing a unified collaborative tool and presentation workspace to access people, resources, and tools within the context of completing a project or task. Files, users, permissions, priorities, individual tasks, statuses, and assets are grouped in a single unified workspace that is centered around the context of completing the task or project. The system provides a framework for a given project or task that is neatly and intuitively organized within the context of that project or task.

Document-based access control for documents within a contextual collaboration allows for access to be provided to users within a same domain (e.g., a company or organization) as well as the owners/originators of the documents. The access control information may “follow” a document. That is, the access level permissions information is embedded within the document (e.g., within the document header or the metadata of the document). As such, the document access controls are not simply limited to a location within the computer file system.

Moreover, the document-based access control of documents provides permissions structures of different levels of access for individual, roles, and group of users that are intuitive and quick to assign and manage (e.g., adding, removing, and/or changing existing designations) within a contextual collaboration.

In some implementations, the document-based access control system provides document control features that improve the workflow of documents within a given organization by enforcing compliance with organizational policies for documents, particularly, the dissemination of confidential documents.

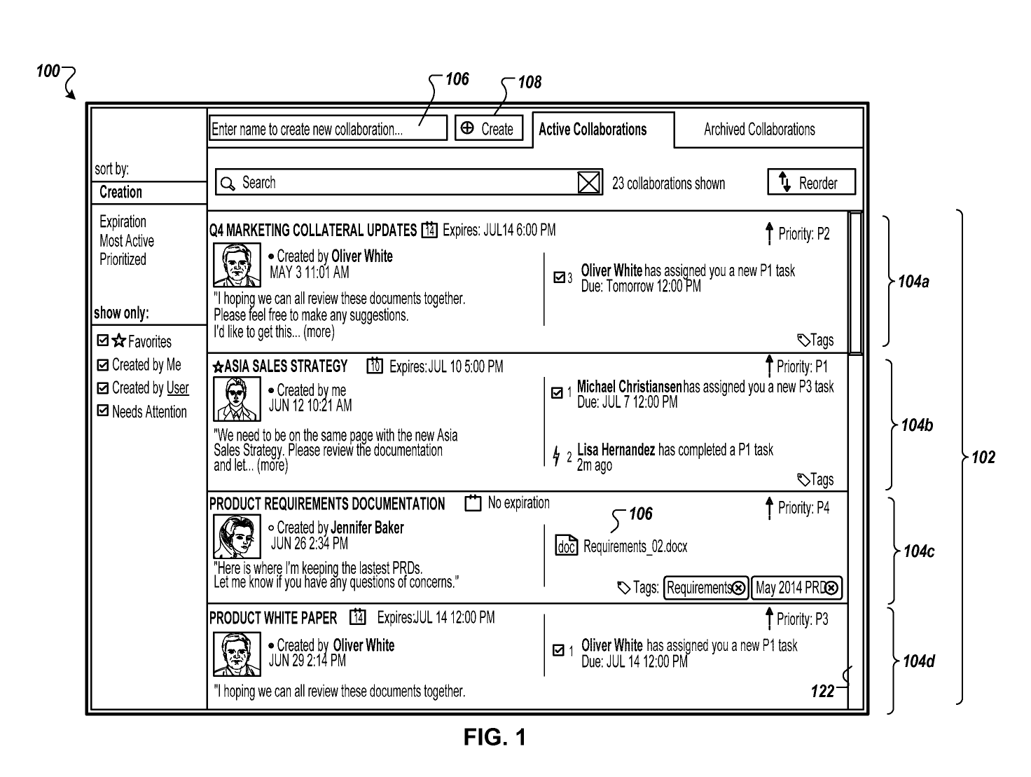

FIG. 1 is a screenshot of a graphical user interface 100 for displaying a context list of contextual collaborations, in accordance with an exemplary embodiment. More specifically, the graphical user interface 100 displays a context list 102 of contextual collaborations 104a, 104b, 104c, and 104d (collectively “104” or “contextual collaborations 104”).

In some example implementations, a graphical user interface (“GUI”) is an interface through which users interact with computing and/or electronic devices. More specifically, using a GUI, users can interact with computing devices by manipulating (e.g., clicking, moving, tapping, selecting, pinching, rotating) graphical elements and/or components typically rendered and/or displayed via a screen, monitor, and the like. In some example implementations, the graphical user interface 100 is displayed via a screen (corresponding to a system (e.g., computer, tablet, mobile device)) managed, operated and/or owned by a user.

In some example implementations, the context list 102 includes a list, table, feed, timeline, and the like, of contextual collaborations 104 with which a user, user system, and/or user account is associated. It should be understood that being associated with a contextual collaboration may include being a creator, owner, participant, operator, contributor, manager, viewer, and the like, with respect to a contextual collaboration. In some example implementations, the context list may be designed, ordered and/or displayed in accordance with preset and/or predetermined requirements, filters, options, and the like, associated with a user and/or user account.

More specifically, the context list 102 includes overview and/or summary information regarding each of the contextual collaborations 104. For example, the context list 102 may include, for each of the contextual collaborations 104a-104d, a contextual collaboration name and/or title, expiration date, creator, creation date, discussions, outstanding tasks, recent activity, priority, tags, associated documents, and the like.

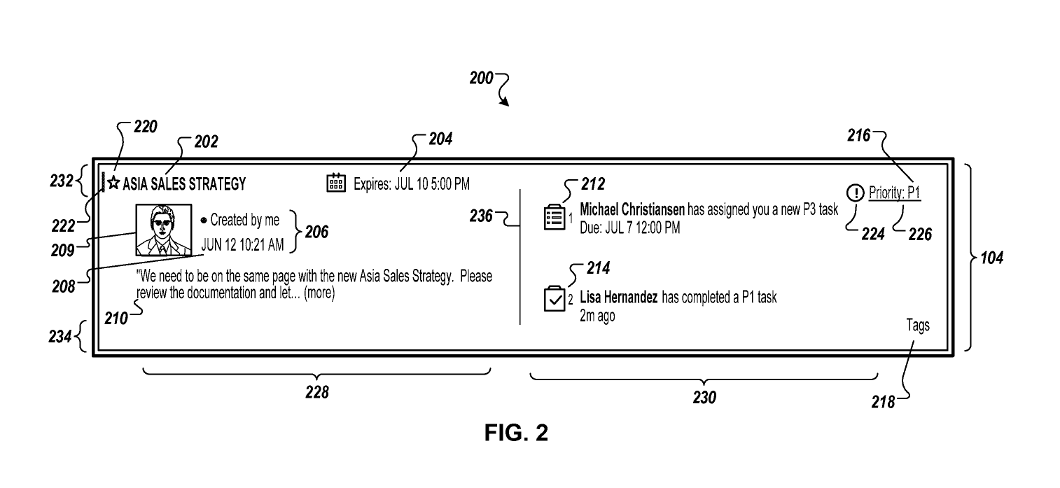

The contextual collaboration name and/or title (e.g., “Q4 MARKETING COLLATERAL UPDATES,” “ASIA SALES STRATEGY,” “PRODUCT REQUIREMENTS DOCUMENTATION,” “PRODUCT WHITE PAPER”) may be text assigned to a contextual collaboration at the time the contextual collaboration is created and/or modified throughout the lifecycle of the contextual collaboration. The expiration date (e.g., contextual collaboration 104a: “JUL 14 6:00 PM”) indicates an assigned date and/or time on which the contextual collaboration is set to expire, which may be the date a project is due. The creator may be the name (e.g., first, last), user name, pseudonym, login name, and the like (e.g., contextual collaboration 104a: “Oliver White”), associated with a user who created the contextual collaboration. The creation date may be the date on which a contextual collaboration was generated (e.g., contextual collaboration 104a: “MAY 3 11:01 AM”). The discussions may be messages, posts, e-mails, threads, tweets, and the like, associated with a contextual collaboration. For each of the contextual collaborations 104, the context list 102 may include any number of discussions (e.g., messages). Moreover, the displayed discussions may be the newest discussion, one flagged with highest priority, one generated by a particular user (e.g., creator), one unread (e.g., not yet viewed), or any other discussion selected in accordance with predetermined criteria. For example, in FIG. 1, the discussion displayed with relation to contextual collaboration 104a reads: “I hoping we can all review these documents together. Please feel free to make any suggestions. I'd like to get this . . . (more).” The “(more)” text may be a link to display the entire discussion. The outstanding tasks may include tasks that are pending action and/or tasks that have been generated, assigned to the user associated with the GUI 100, and/or tasks that have not yet been read by the user associated with the GUI 100. For example, in FIG. 1, the contextual collaboration 104a includes a “new P1 task” assigned by Oliver White and due “Tomorrow 12:00 PM.” In some example implementations, recent activity may include the creation of new tasks, such as “new P1 task” associated with the contextual collaboration 104a. In some example implementations, recent activity may include the completion of tasks (e.g., contextual collaboration 104b: “Lisa Hernandez has completed a P1 task”). The priority may refer to text, an icon, or the like that indicates a level and/or order of priority for each contextual collaboration. In some example implementations, the priority may be indicated by identifiers P1, P2, P3 and P4 (e.g., P1 indicating highest level of priority). In this manner, the user associated with the GUI 100 can identify the importance of the contextual collaborations. The tags may refer to a text, icon, or the like that can be used to quickly identify contextual collaborations having the same tag. That is, in FIG. 1, for example, the contextual collaboration 104c includes tags “Requirements” and “May 2014 PRD,” which server to identify the contextual collaboration as a requirements (e.g., product requirements) related collaboration, particularly a May 2014 product requirements documentation (PRD) contextual collaboration (e.g., “May 2014 PRD”). As described above, other information related to the contextual collaborations, and any number of contextual collaborations, may be displayed in the context list 102. The information included and/or displayed for each contextual collaboration is described in further detail below with reference to FIG. 2.

The context list 102 may be used, for example, to organize and prioritize contextual collaborations, tasks and projects with which they are associated and/or to which they are assigned.

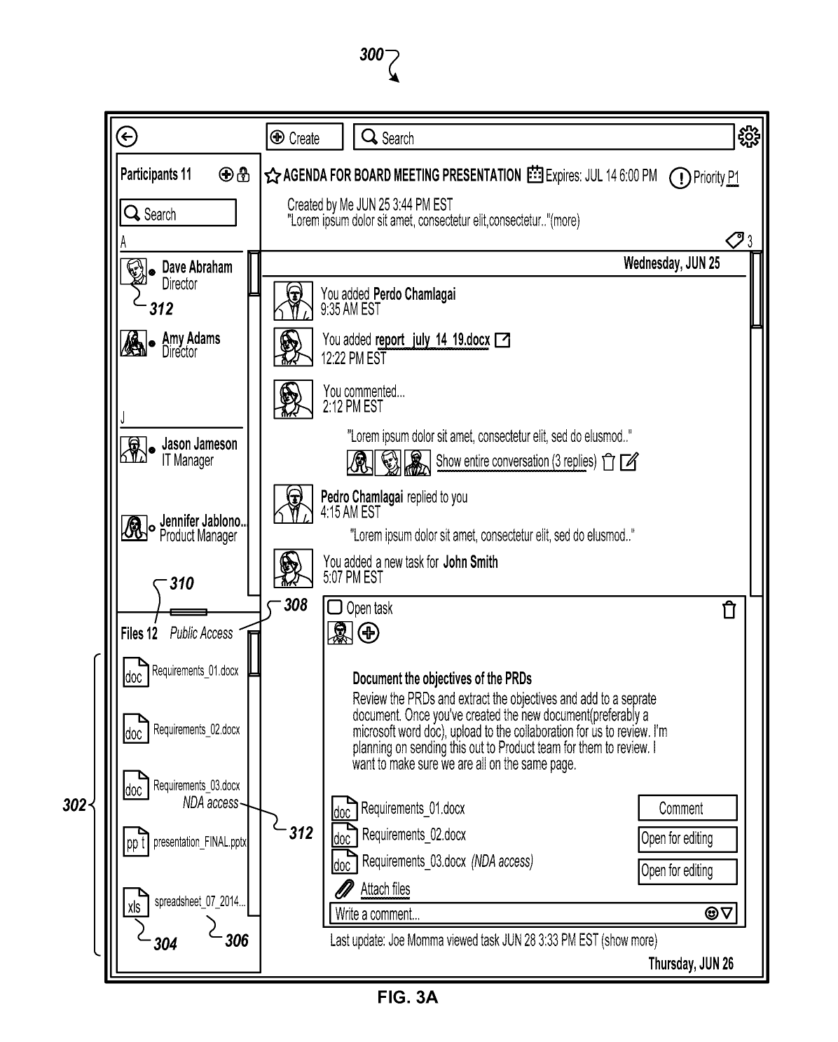

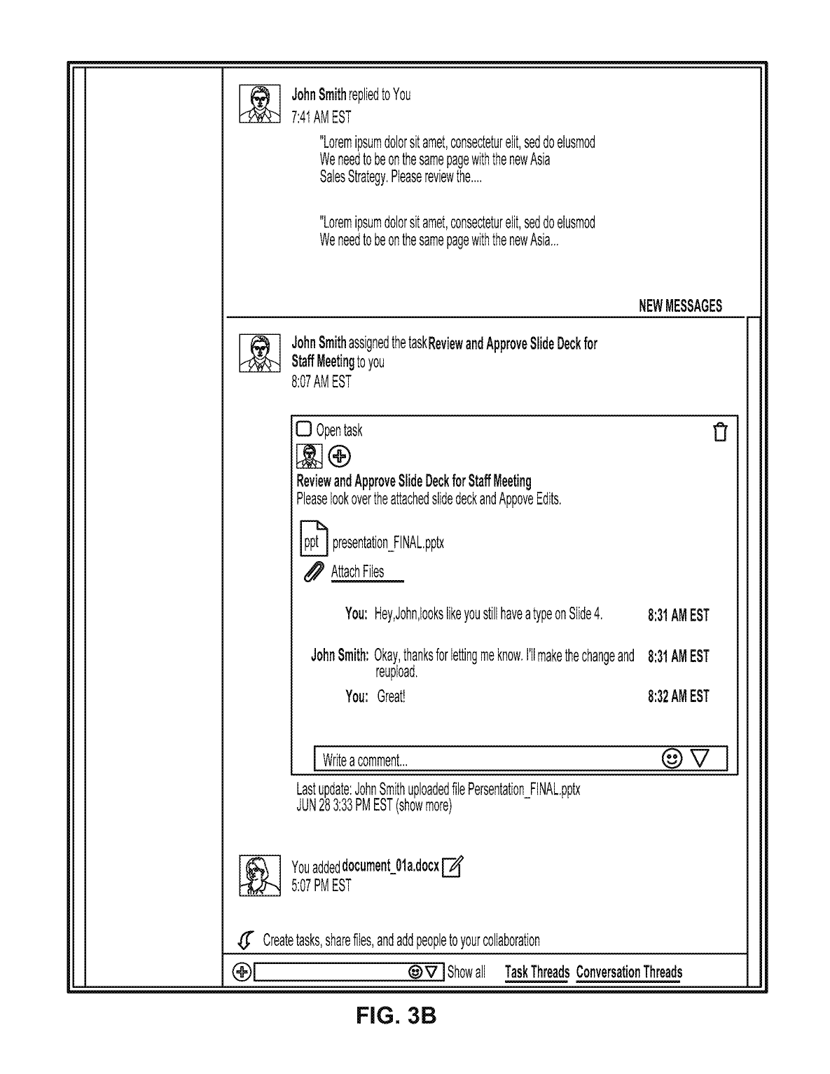

A contextual collaborations with which multiple users are associated may be accessible by each user through a respective workspace. That is, a contextual collaboration that is shared with other users is made available to the users through respective workspaces included in a GUI. In this manner, multiple users associated with a contextual collaboration can contribute and share information, documents, resources, and the like within the context of a contextual collaborations. Workspaces may be individually tailored to each user, for example, to include only information and/or resources to which the user has access. Workspaces are described in more detail below with reference to FIGS. 3A and 3B. The users may include those that are within the same organization/business domain, as well as users external to the organization/domain, assuming access permission is granted.

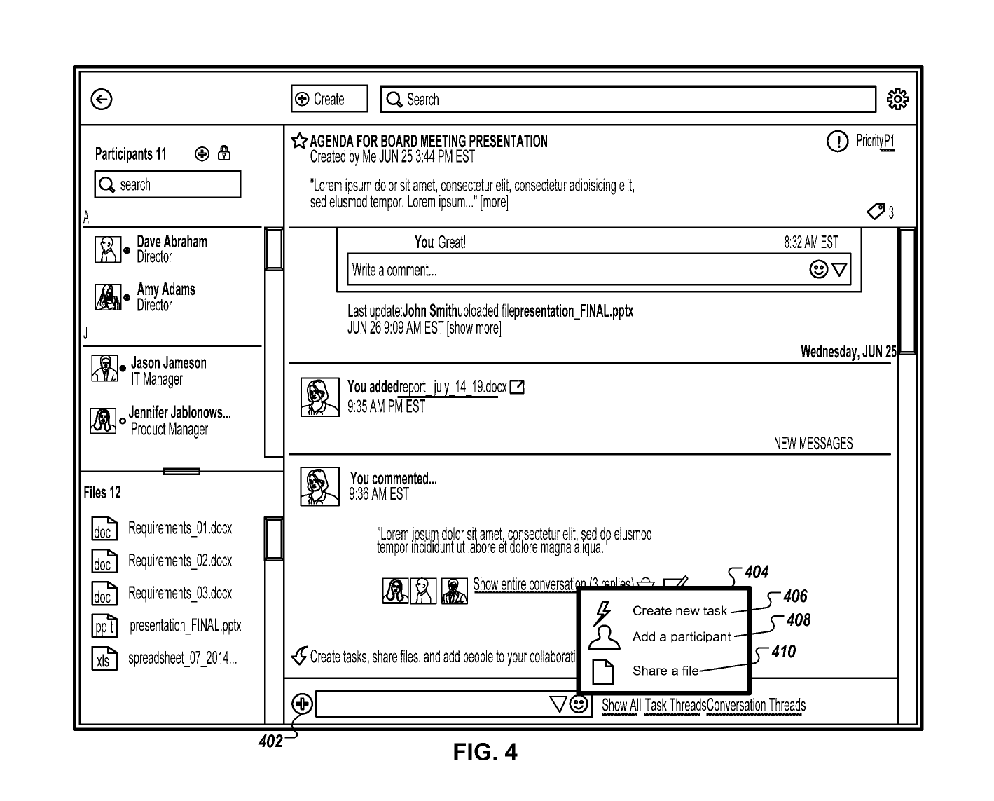

To create a contextual collaboration, a user can specify a collaboration name via a graphical input and/or prompt. As shown in FIG. 1, for example, the system graphically renders a text input 106 and widget 108. Additional information and settings for the contextual collaboration (e.g., collaboration description, users, files/documents, priority level, permissions, favorite, expiration date, states, tasks, and other configurations as described herein), may be subsequently added, for example, when the contextual collaboration is in the active state. A contextual collaboration may be added by the user through an Operating System window and from email integration. In some implementations, upon clicking on the button 108, the interface expands to show a “create new collaboration” area. FIG. 4 is a screenshot of an exemplary graphical user interface of an active collaboration with a “create new collaboration” area (e.g., 404).

FIG. 2 is a screenshot of a graphical user interface 200 (or a portion thereof) for displaying a contextual collaboration, in accordance with an exemplary embodiment. It should be understood that displaying a contextual collaboration may include retrieving, requesting, transmitting and/or displaying information associated with the contextual collaboration. The graphical user interface 200 may be displayed at and/or by a system (e.g., computing device) corresponding to a user.

The contextual collaboration 104 (e.g., FIG. 1, contextual collaboration 104b), in some example implementations, includes and/or graphically indicates one or more of a name and/or title 202, expiration date and/or time 204, a creator 206, user icon and/or avatar 207, a creation time 208, discussions 210, tasks 212, statuses 214, priority level 216, tags 218, favorite indicators 220, and change indicators 222. As show in FIG. 2, in some example implementations, the information may be divided by a panel or pane division line 236. That is, for example, the contextual collaboration information may be divided into file, user, messages information 228 and task information 230.

The contextual collaboration name and/or title 202 is described in more detail above with reference to FIG. 1. In some example implementations, the contextual collaboration name and/or title may be text assigned to a contextual collaboration at the time the contextual collaboration is created and/or modified throughout the lifecycle of the contextual collaboration (e.g., “ASIA SALES STRATEGY”). The expiration date and/or time 204 indicates an assigned date and/or time on which the contextual collaboration is set to expire, which may be the date a project is due (e.g., “JUL 10 5:00 PM”). The creator 206 may be the name (e.g., first, last), user name, pseudonym, login name, and the like (e.g., “me”), associated with a user who created the contextual collaboration 104. The user icon and/or avatar 207 may be a picture, image, icon, avatar, and the like associated with the creator 206. The creation time 208 may be a date and/or time (e.g., “JUN 12 10:21 AM”) on which the contextual collaboration 104 was created. The discussions 210 may be messages, posts, e-mails, threads, tweets, and the like, associated with a contextual collaboration (e.g., “We need to be on the same page . . . ”). The contextual collaboration 104 may include any number of discussions (e.g., messages). Moreover, the displayed discussions 210 may be the newest discussion, one flagged with highest priority, one generated by a particular user (e.g., creator), one unread (e.g., not yet viewed), or any other discussion selected in accordance with predetermined criteria. The tasks 212 may include tasks that are pending action and/or tasks that have been generated, completed, assigned to the user associated with the GUI 100, and/or tasks that have not yet been read by the user. The statuses (e.g., recent activity) 214 may include and/or indicate the completion of tasks (e.g., “Lisa Hernandez has completed a P1 task”), as well as an indication of the date and/or time on which the status and/or updated activity was completed (e.g., “2 m ago”). The priority level 216 may refer to text, an icon, or the like that indicates a level and/or order of priority for each contextual collaboration. In some example implementations, the priority may be indicated by identifiers P1, P2, P3 and P4 (e.g., P1 indicating highest level of priority). The priority level 216 may be highlighted by underlining (e.g., underlining 226) and/or be accompanied by an icon (e.g., exclamation mark 224) to further emphasize the priority level 216. The tags 218 may refer to a text, icon, or the like that can be used to quickly identify contextual collaborations having the same tag.

A contextual collaborations generally has one or more users associated with it. Users are individuals (including their corresponding systems) who are registered with the system (e.g., contextual collaboration system), have account credentials (e.g., user name, password). Users who generate, add and/or initiate a contextual collaboration are deemed to be creators of that contextual collaboration. Users who add documents and/or other resources to a contextual collaboration are deemed to be owners of the documents and/or resources which they contributed.

In some example implementations, a document owner may set permissions for documents in a contextual collaboration. For example, the owner can establish whether the document can be added to contextual collaborations or tasks, whether the document can be commented on, and/or whether the document can be edited. In some example implementations, setting permissions for a document is performed by submitting inputs via a workspace, for example, by selecting (e.g., clicking, tapping) a permissions icon (e.g., key) or the like.

Users of a contextual collaboration generally have permission to perform certain actions with respect to the contextual collaboration, based on each user's level (e.g., generic user, creator, owner). Such permissions may include executing commands; receiving notifications; adding, modifying, and/or removing users; adding, modifying, and/or removing documents; adding, modifying, and/or removing resources, instantiating live-share; modifying and/or applying version numbers to documents and/or resources; setting permissions; setting and/or modifying priorities; setting and/or modifying expiration dates; deleting and/or archiving contextual collaborations; changing and/or adding states of contextual collaborations; and the like.

A contextual collaboration generally has one or more resources associated with it. Resources have a lifecycle and exist in at least one contextual collaboration, which can be created, manipulated and ultimately terminated or retired. The contextual collaboration (e.g., contextual graph) structure, in some example implementations, organizes contextual collaborations conceptually on a timeline and/or by priority. To this end, at any point in time a user of the system can view their timeline or priority and see what contexts (and therefore what resources within those contexts) are involved in the activities they are working on.

For example, a contextual collaboration can be in connection with the production, approval, and archival of documents (and/or files). In further example, a context may be framed as a meeting with relationships or links to: the attendees of the meeting, the documents to be presented in the meeting, devices (projectors or displays) that the meeting will use, and the location(s) of the meeting and/or the scheduled time. This contextual collaboration (e.g., contextual graph) information model, is used to orchestrate the meeting. For example, read access to the documents may be granted (e.g., automatically) to the attendees of the meeting once the documents and attendees are associated to the contextual collaboration. Similarly, the documents may be automatically available for display on any display available in any of the meeting locations if associated within the contextual collaboration.

FIGS. 3A and 3B are screenshots of a graphical user interfaces for displaying a contextual collaboration workspace 300. The contextual collaboration workspace 300 serves as an interface to, for example, output information and receive inputs with respect to a contextual collaboration. The contextual collection workspace 300, in some implementations, is accessed by selecting (e.g., tapping, clicking, double-clicking) a contextual collaboration (e.g., 104a-d) from the context list 102. In some example implementations, the contextual collaboration workspace 300 is displayed at a computing device.

The contextual collaboration workspace 300 of a contextual collaboration, in some implementations, graphically renders and/or displays a document list 302 associated with the contextual collaboration. The document list 302, in some example implementations, includes (and/or displays), for each document, a graphical widget 304 (e.g., icon or the like) to indicate a type of document (e.g., a presentation, a spreadsheet, or a word processing file), and a document name 306. The document list 302, in some example implementations, includes (and/or displays) an access level designation indicator 308 for the files listed in the document list 302. The document list 302 may display information such as the access level designation based on the information included in each of the documents. The document list may enforce the access control restrictions of a document, for example, by prompting a user when the user attempts to access (e.g., view, access, copy, and/or move) the document. The document list 302, in some example implementations, graphically displays an indicator 310 illustrating the total number of documents associated with the workspace 300 and/or displayed in the document list 302.

The document list 302, in some example implementations, graphically displays the types of access-level designations that are associated with the documents of the document list 302 within a given contextual collaboration workspace. For example, the document list 302 includes access-level designations such as Public Access 308 and NDA access 312. In some example implementations, an indicator for the default access-level control designation may be shown.

In some example implementations, the documents in the document list 302 include and/or are associated with access levels (e.g., access level designations, pre-defined set of access-level designations) such as: Named User, Domain User, NDA Restricted (e.g., NDA access 312), and Public Access (e.g., Public Access 308). The levels of access, in some example implementations, are mandatory and mutually exclusive. That is, in such example implementations, a document must have only one access level designation. In some example implementations, all documents within a document series (e.g., set of associated documents, multiple versions of a document, family of documents) have and/or are assigned the same access level designation.

Access level designations allow for varying degrees of restricted access to information (e.g., documents) associated with a contextual collaboration. In some example implementations, the access level restrictions accommodate and/or provide “Right to Know” access privilege levels for confidential and restricted documents. For example, the access level designations may restrict access based on domain association, user identity, title, role, computing device specifications. The access level restrictions also accommodate and/or provide “Need to Know” access privileged levels. The access level restrictions may be provided to and/or enforced on resources (e.g., documents) within a context list, contextual collaboration, contextual collaboration workspace, and/or Live Share sessions.

Participants (e.g., users) of a contextual collaboration may initiate a Live Share session directly from the contextual collaboration. When initiating a Live Share session, the initiator of the Live Share session may select participants from the participant list or, if no participants are selected, all participants may be included. During a Live Share session or when initiating the session, the initiator of the Live Share can select any document from the list available in the contextual collaboration to share with the other participants. Users may also send comments to the Live Share participants by writing the comment in a comment box (e.g., located at the bottom of the Live Share session). A record of the Live Share session may be stored in the contextual collaboration for reference.

In some implementations a default access level may be assigned and/or provided to a document. For example, by default, documents may be set to “Public Access,” which may allow any user or the like (e.g., public) to access the documents. The default access level may be changed by modifying preferences and/or configurations of documents, context lists, collaborations, workspaces or the like. The default access level may also be changed globally (e.g., by a system administrator). In some example implementations, a context owner (e.g., a user that created or originated a given contextual collaboration) may not have permission to change the default access level of a document or series included in the contextual collaboration.

In some example implementations, access level restrictions (e.g., first user access designation) are user-based. That is, a first user access level restrictions may be assigned based on user identity or specifications of computing devices associated with a user. User-based access level restrictions (e.g., pre-defined set of access-levels) allow documents to be accessed (e.g., view, modify, etc.) based on the user attempting the access. For example, user-based access level restrictions may be set specifically for document owners (e.g., users that have added and/or created documents) or other users (e.g., users designated and/or added by, for example, document owners). That is, in some example implementations, access level is limited to those users having an identity or identifier that matches that of the named user in the access level designations. In some example implementations, named (e.g., permitted) users of documents or document series are distinct from document owners. That is, named users, for example, may not be permitted to add new named users or otherwise change permissions on the documents. In some example implementations, the named user may be a user from outside a domain or company managing and/or associated with a contextual collaboration.

Document owners and named users may add documents to contextual list, contextual collaborations, contextual collaboration workspaces, and/or Live Share sessions to which they are associated with and/or permitted. In some example implementations, only users who are named users or document owners would have permission to view and/or edit documents from within a contextual collaboration workspace.

In some example implementations, the first user-access designations (e.g., named user and/or private designations) operate independently of the other access levels designation. That is, the document owner, for example, explicitly sets the access level restriction for it to apply to a given document.

In some example implementations, access levels (e.g., pre-defined access levels) include a second user-access designation (e.g., a domain user, restricted access designation). The second user-access designation allows the document to be viewed and accessed by: (i) a document owner (e.g., a user that has added the given document to the contextual collaboration) and/or (ii) a domain user. A domain user may be a member of a specified domain designated by the document owner to have access to the document where the domain is based and/or with which the document is associated, including on an organization identifier, an email domain, or a website domain, and wherein the user is located (e.g., an internal or external member of the domain associated with the document owner). In some example implementations, the document owner explicitly sets this access level restriction.

In some example implementations, access levels include a third user-access designation (e.g., a non-disclosure-agreement, confidential user-access designation). The third user-access designation allows the document to be viewed and accessed by: (i) a document owner (e.g., a user that has added the given document to the collaborative system) and/or (ii) a domain user. A domain user may be a user who is a member of a specified domain designated by the document owner to have access to the document where the domain is based and/or with which the document is associated, e.g., on an organization identifier, an email domain, or a website domain, and where the user is, (e.g., an internal or external member of the domain associated with the document owner). The third user-access designation, in some example implementations, causes the system to prompt the document owner, when adding the given document to a contextual collaboration, to affirm that each user associated with the given contextual collaboration is subject to an agreement (e.g., a non-disclosure or confidentiality agreement) to have access to the document. In some example implementations, the document owner explicitly sets this access level restriction.

As mentioned above, FIG. 4 is a screenshot of an exemplary graphical user interface of a contextual collaboration including an area 404 (e.g., window, panel or the like) for adding collaborators (e.g., participants, users). Area 404 includes commands for adding a new task (406), adding a participant (408) and sharing a file (410). Selecting command 408 in the area 404 causes prompts, if necessary to ensure that a new participant is given the appropriate access to documents in the contextual collaboration.

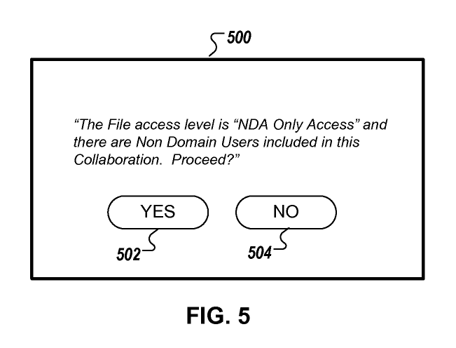

FIG. 5 illustrates a dialog box prompt 500 for managing external participants to a contextual collaboration, according to an exemplary embodiment. When a document with a third access-level designation (e.g., “NDA Only” document) is added to a context that includes external participants (e.g., participants from other companies), the user adding the document may be prompted to affirm and/or confirm that each external participant has entered in to an appropriate agreement (e.g., NDA) allowing access to the document. The prompt may be a dialogue box 500 that includes one or more graphical inputs (e.g., 502 “YES” and 504 “NO”) for the user to affirm or decline that a new external participant has an appropriate agreement in place with the user's company or organization to view the document. In some example implementations, the system compares, when a document is added, the company domain of each participant of a contextual collaboration to the domain of the document owner to determine if any external participants are associated with a contextual collaboration and/or attempting to access the contextual collaboration.

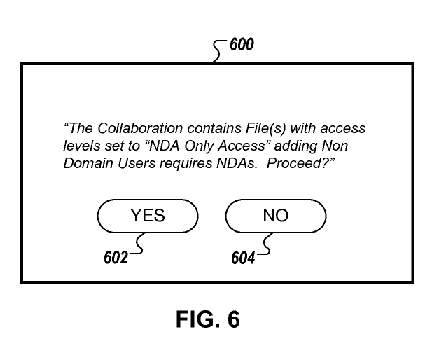

FIG. 6 illustrates a dialog box prompt 600 for managing external participants to a contextual collaboration, according to an exemplary embodiment. In some example implementations, a prompt is presented when a user adds or invites an external user to a given contextual collaboration to which a document having the third access-level designation is associated. The prompt may be a dialogue box 600 that includes one or more graphical inputs (e.g., 602 “YES” and 604 “NO”) for the user to affirm or decline that the new external participant has an appropriate agreement in place with the user's company or organization to view document.

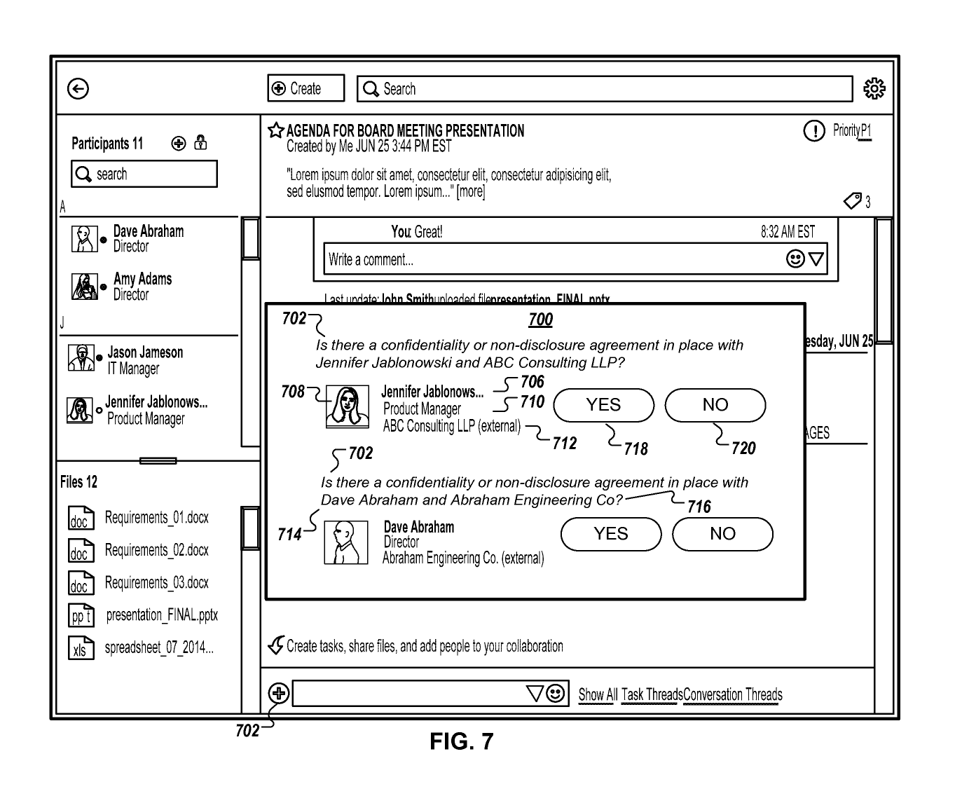

FIG. 7 illustrates a dialog box prompt 700 for confirming confidentiality permissions, according to an exemplary embodiment. In some example implementations, a list of external participants of the contextual collaboration is graphically presented and/or displayed when adding a document to a contextual collaboration. The graphical presentation may be a dialogue box. Within the dialogue box, a message is presented along with an input widget (e.g., a check box, a button, a textual link) corresponding to each external participant. The input widget is used to identify whether an external participant has a non-disclosure agreement in place. The user may manually checks (e.g., input) each external participant.

As shown in FIG. 7, in some example implementations, the dialogue box 700 includes a message 702 indicating the participant and the company/organization to which they are affiliated. In some example implementations, the dialogue box 700 presents the name of the participant 706, an icon or photo of the participant 708, a title or role of the participant 710, and a name of identifier of the company/organization 712 to which the external participant is affiliated. In some example implementations, the message 702 illustrates the name of the participant 714 and the name of the company/organization 716. The dialogue box 700, in some example implementations, includes input widget (e.g., 718 and 720) for each participant to affirm or decline.

To promote compliance with a company's confidentiality and/or document policies, the message (e.g., 702) may include a guidance message to the user and/or annunciation of a policy. In some example implementations, the message is configurable (e.g., from a default message) via a configuration panel of a system administrator. In some example implementations, the message is substituted or supplemented with a message provided by the document owner in a dialogue box that is presented to the document owner when the document is being added to or associated with a contextual collaboration.

In some example implementations, the dialogue box 700 provides the user with means to complete the action of adding a document with the third access level designation when only some of the participants listed have been affirmed by the user. That is, not all of the participants in the dialog box have to be affirmed or declined. In such instances, external participants who are not checked as having an appropriate agreement in place are not able to access the document (e.g., from the context list or the contextual collaboration workspace). In some example implementations, the document are not visible to such external users.

To promote compliance and ease-of-use in managing contextual collaborations, in some example implementations, a graphical indication is provided to the owner and participants of a contextual collaboration having documents with the third access level designation (e.g., “NDA Only” document). The graphical indication, in some example implementations, is presented within the context list 102 for a context owner and participant.

In some example implementations, documents having the third access-level designation (e.g., “NDA Only” documents) are restricted (e.g., accessible, viewable, and editable) by users within the same domain with the document owner, but not public users.

In some example implementations, pre-defined access levels include a fourth user-access designation (e.g., a public and/or default access designation). The fourth user-access designation allows the document to be viewed and accessed by: (i) a document owner (e.g., a user that has added the document to the contextual collaboration) and (ii) users within a domain associated with the document owner or all users associated with the contextual collaboration to which the document is associated. The restriction may be selected, for example, by the system administrator to define a “default” access level designation for documents and files when added to the collaboration system.

In some example implementations, documents that are added to the system are designated with a fourth access-level designation (i.e., public access level), for example, by default (e.g., without having to be explicitly designated by the document owner). A document and/or series thereof with the fourth access-level designation (e.g, public access level) are visible to all owners and participants in a context list or contextual collaboration workspace containing the document. Of course, other access level designations may be employed.

It should be appreciated that other nomenclatures and/or labels for the specific access level designation may be employed. Such nomenclatures, in some implementations, are configurable by the system administrator through a configuration panel. In the event that a company does not employ a custom nomenclature, the nomenclatures described herein may be employed by default.

In some example implementations, for documents to which a given user does not have access as determined from the access level designation, the interface graphically indicates in the workspace 300 that there are documents that are associated with the contextual collaboration that are not being presented in the workspace 300. In some example implementations, the interface displays a document name and/or owner of the document. The indication of the name and/owner of the document, in some example implementations, is greyed out to indicate that the document is not accessible to the given user.

The document list 302 may graphically display graphical widgets 312 that indicate that a document has a non-default document-access level designation. For example, for a collaboration system configured with the a “public access” designation, a document having a different designation level than “public access” would be presented with a graphical widget 312. The graphical widget 312, in some example implementations, are displayed in the workspace 300 in which a given document is presented.

To aid in managing contexts and participants with differing roles within the context list 102, in some example implementations, context collaborations 104a-d are graphically rendered to have an indication of all the types of documents that are contained therein. For example, a context list 102 that contains both a “Domain User” document (e.g., a document designated with the second access-level designation) and a “Public Access” document (e.g., a document designated with the fourth access-level designation) includes such corresponding graphical designations for those documents within the context list 102. In another example, if the contextual collaboration 104 of the context list 102 contains only “Public Access” documents, the contextual collaboration 104 and/or context list 102 graphically indicates that it is a “Public Access” collaborations. The graphical indication, in some example implementations, includes a textual label, color schemes, icons, flags, and other graphical widget to indicate the designation.

The contextual collaboration workspace 300 of a contextual collaboration, in some example implementations, graphically renders a participant list 302 of users associated with the contextual collaboration. The participant list 302, in some example implementations, includes, for each user associated with the contextual collaboration, a name identifier 304 of the user, a title 306, an associated organization 308 (not shown), and a number of users 310 associated with the contextual collaboration. Each user may include or be associated with a photo or icon 312 and a presence status indicator 324.

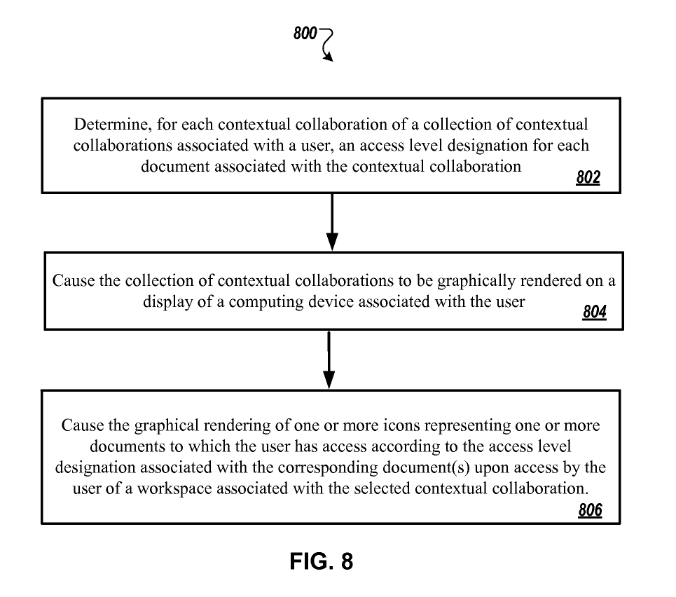

FIG. 8 is a flowchart illustrating a method 800 for granting and/or restricting access to documents associated with one or more contextual collaborations. At step 802, for each contextual collaboration of a collection of contextual collaborations associated with a user, an access level designation is determined for each document associated with a contextual collaboration. The access level designation is selectable (e.g., by an owner/originator of the document and/or contextual collaboration) from a pre-defined set of access level designations (e.g., named user/private, domain user/restricted, NDA/confidential, and public/default), as described above in further detail with reference to FIGS. 3A and 3B. In turn, at step 804, the collection of contextual collaborations are graphically rendered on a display of a computing device associated with the user.

In turn, at step 806, one or more icons corresponding to the one or more documents to which the user has access are rendered according to the access level designation associated with the documents. For example, rendering of icons may be performed upon and/or in response to access or an access attempt by the user of a workspace associated with the selected contextual collaboration.

In some example implementations, access level designations may be provided to any resources associated with a contextual collaboration, including persons, documents, locations (e.g., rooms, buildings), devices, assignments, printers, presentation hardware, computers, display monitors, tasks, calendars, documents, multimedia files (e.g., videos), graphics, audio files, and the like.

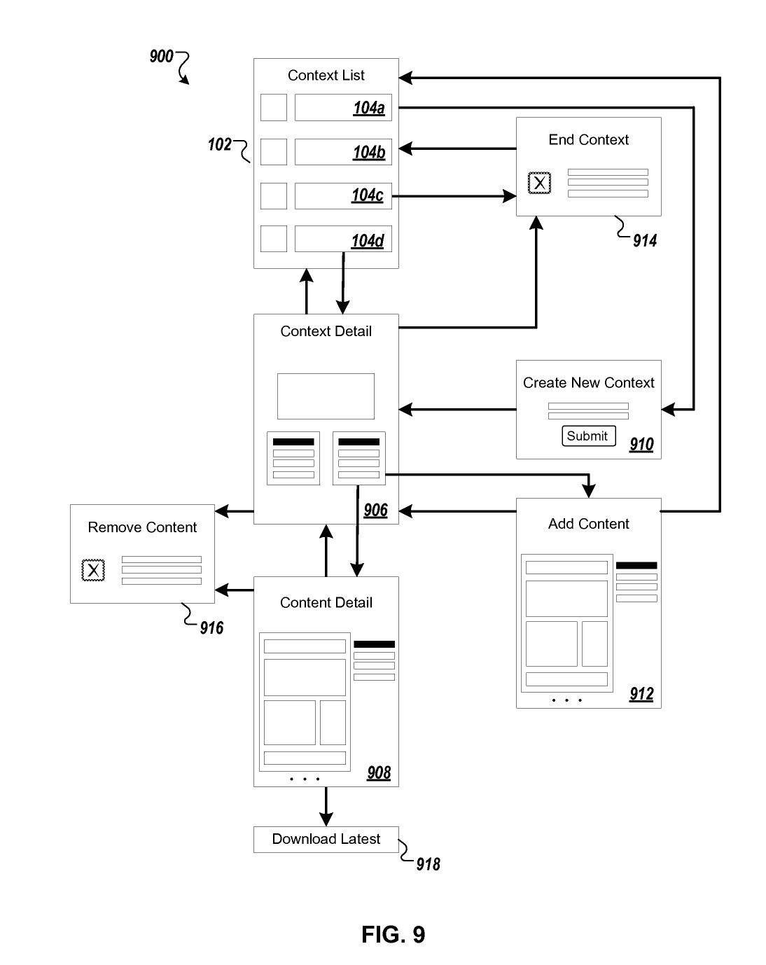

FIG. 9 is a block diagram of a system 900 for enterprise management using contextual collaborations (e.g., contextual graphs), according to an exemplary embodiment. In some example implementations, the system 900 is an enterprise system that provides contextual collaborations 104 (e.g., 104a, 104b, 104c, 104d) that relate documents, resources, and the like that occur and/or are used in business workflows. The contextual collaborations 104 may be displayed and/or provided on a context list 102, and may be organized, for example, based on time or priority level. In this way, the system can output (e.g., display, transmit, provide), and a user can access and/or view, the timeline or priority level of projects, tasks and the like associated with the contextual collaborations 104 (and documents and/or resources associated therewith).

The context list 102 enables access to the resources associated with the contextual collaborations 104 in the context list 102. Examples of resources include one or more persons, documents, locations (e.g., rooms, buildings), devices, assignments, printers, presentation hardware, computers, display monitors, tasks, calendars, documents, multimedia files (e.g., videos), graphics, audio files, and the like.

For example, a user may select a contextual collaboration 104d and view context details 906 associated with the contextual collaboration 104d. In some example implementations, the contextual collaboration 104d is a meeting includes and/or is associated with contents (e.g., content details) 908. The context detail 906 provides content (e.g., the content itself, and/or a relationship or link associated with the content), such as the attendees of the meeting, the documents to be presented in the meeting, devices (e.g., projectors or displays) to be used in the meeting and/or the scheduled time. At block 918, details regarding the content 908 (e.g., content detail) associated with the contextual collaboration 104d in the context list 102 may be downloaded.

A contextual collaboration (e.g., contextual collaboration 910) may be added to the context list 102. A contextual collaboration (e.g., contextual collaboration 914) may be deleted and/or removed from the context list 102. In some example implementations, the context list 102 is updated when contextual collaborations are added or removed from a context list 102. Similarly, in some example implementations, the system updates the contextual collaboration 906 and/or the context list 102 when content is added to or removed from a context detail 906.

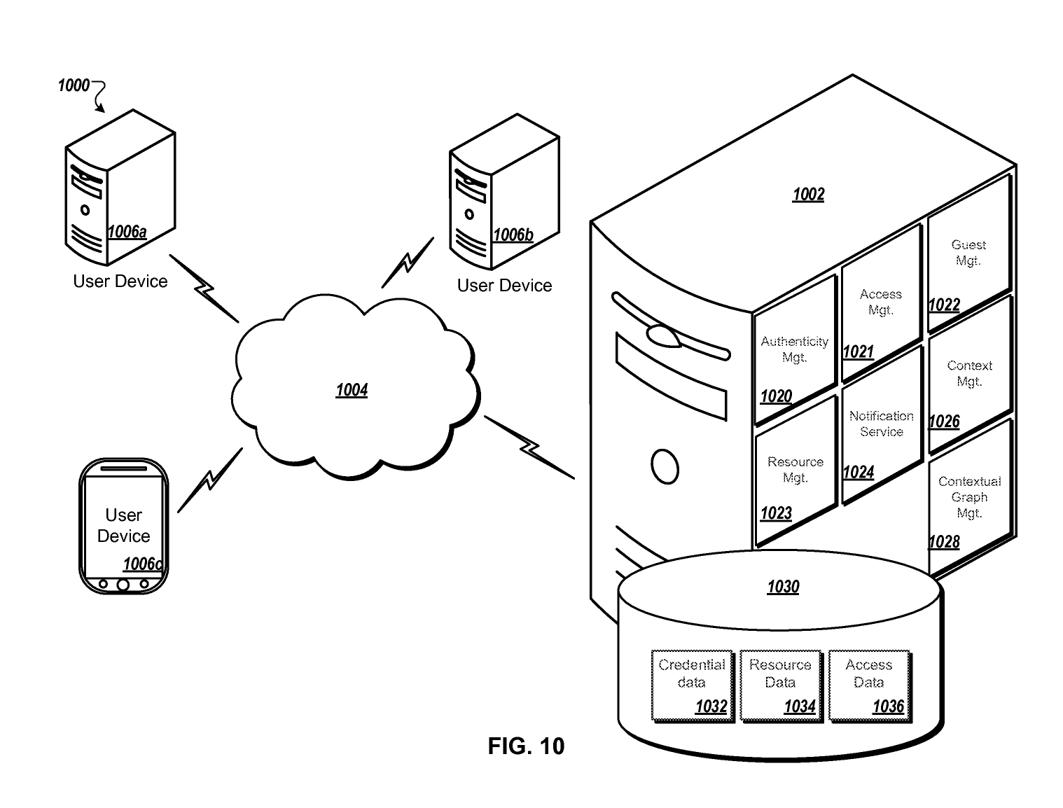

FIG. 10 is a block diagram of a system 1000 for enterprise management using contextual collaborations (e.g., contextual graphs), according to an exemplary embodiment. The system 1000 includes an enterprise system 1002, user computing devices 1006a, 1006b and 1006c (collectively “1006” or “user devices 1006”), and a network 1004. The enterprise system 1002 may be accessed from one of the user devices 1006 via the network 1004. In some example implementations, each of the computing devices 1006 is configured with a client application that provides access to features and functions provided by the enterprise system 1002. The enterprise system 1002 includes one or more processors for controlling the functionality of the enterprise system 1002. The computing devices 1002 may be desktop computers, laptops, workstations, personal digital assistants, cellular telephones, smart-phones, tablets, and other similar computing devices. The network 1004 may be the Internet, an intra-enterprise network, and/or other similar networks, or a combination thereof.

The computing devices 1006 may access the enterprise system 1002, for example, by inputting and/or transmitting login information to the enterprise system 1002. In some example implementations, an authenticity module 1020 authenticates the login information (e.g., associated with a user). The authenticity module 1020 may compare the login information to credential data 1032 stored in a data store 1030. The data store 1030 may be one or more memory devices attached to and/or in communication with the enterprise system 1002. The login information and/or the credential data 1032 includes, for example, a username, password, name, address, phone number, age, security question information, date of birth, place of birth, identification number, social security number, telephone number, email address, passport number, company name, group name, business unit name, an employee identification number, biometric characteristics (e.g., fingerprints, palm prints, iris scan, retina scan, facial scan, hand geometry, odor, vein pattern, voiceprint, typing rhythm, gait, dynamic signature, static signature), or the like, or any combination thereof. The credential data 1032, in some implementations, may be provided and/or stored during or subsequent to a registration process.

In turn (e.g., after login information has been authenticated by the authenticity module 1020) a context list may be presented via a contextual collaboration workspace, as described above in more detail with reference to FIGS. 1-5.

In one example implementation, upon accessing an application, a user is prompted for login credentials. The input login credentials are in turn validated against a configured AD/LDAP server (e.g., an active directory and/or lightweight directory access protocol server) or internally in the case of an internally defined system or system created user. If the user has previously signed on and they have not logged out of the system, the user may not be required to go through the login procedure. After gaining access to the system, the user is presented with the main window of the application. That is, a window application is displayed at a computing device operated by and/or associated with the user.

A contextual collaboration (e.g., graph) management module 1028 manages contextual lists and a context management module 1026 manages each of the contextual collaborations. The context management module 1026 and contextual collaboration management module 1028, in some example implementations, work together to create and update a business workflow model (e.g., a contextual collaboration and/or graph) for an enterprise. The modules described herein may be separate modules, combined into a single module, or distributed into any number of modules. A context list may be created for each user associated with the enterprise (e.g., employees of the enterprise, guests of the enterprise, administrators of the enterprise, etc.). Each context list may be tailored and/or designed specifically for each user or group of users, and contains one or more contextual collaborations. A context list enables access to resources assigned to and/or associated with a contextual collaboration in the context list.

In some example implementations, a user requests to authorize another user (e.g., guest user) for guest access to a set of system and/or contextual collaboration resources. The guest user may already be a registered user or may be a new user to the system. A guest management module 1022, in some implementations, controls guest access to the system, including authorizing the guest user to access the requested resources or a subset of the requested resources. The authorization, in some implementations, is based on specific name of the user or a domain identifier associated with an organization of which the user is a member.

For example, an enterprise may maintain a system (e.g., enterprise system 1002), as described in the present application. A user of the system may be an employee of the enterprise. The employee may request that another user (e.g., guest user) receive guest access to the system. The guest user may be a non-employee of the enterprise. The non-employee guest user may be a contract worker, friend, family member, business associate, or have some other similar relationship with the employee. For example, an employee may wish to register a spouse as a guest so the spouse can access information on the system relevant to health benefits. The employee may also request to provide guest access to a contract worker so that the contract worker can perform his/her required duties. In each case, the access may be preset and/or is configurable by, in this example, the employee so that the guest can access the appropriate system resources.

Guest users may submit requests for access to a set of resources by another guest user. In some example implementations, guest users are not permitted to request access to the system by another guest user. For example, only users registered with the system are permitted to submit requests to authorize users for guest access to the system. In some example implementations, the system permits a guest user to request a second guest user. This may be limited to situations when the second guest user has been previously registered with the system or when the second guest user meets a predetermined qualification (e.g., if the guests are coworkers).

Credentials associated with the new guest user may be received. In some example implementations, the set of credentials are stored in the credential data 1032 in the data store 1030. The set of credentials associated with the guest user may be provided by a user, the guest user, or by both a user and the guest user. For example, the user may provide one credential of the set of credentials and the guest user provide another credential of the set of credentials. The set of credentials and/or other information associated with the guest user may be stored for future use.

In some example implementations, the guest management module 1022 verifies that the second set of credentials associated with the second user meet one or more predetermined criteria for guest-level access to the system. For example, the guest management module 522 may verify that the second user is not prohibited from accessing a system resource that would otherwise be accessible based on the set of credentials. In some implementations, this is accomplished by verifying the user is not on a “no-access” list.

In some example implementations, after a user is authenticated, the user has access to a set of system resources. The set of system resources, in some implementations, is stored on the data store 1030 and includes resource data 1034. An access management module 1021, in some example implementations, control a user's access to system resources. In some implementations, the access management module 1021 controls both users that are employees of the enterprise and/or guest users.

For example, a user may be an employee with non-administrator employee access to system resources. When the employee logs into the system and is authenticated, the access management module 1021 may limit the employee's access to system resources accessible to non-administrator employee access.

In some example implementations, a user's level of access may be based on one or more permissions associated with the user. The permissions may be based on access data 336 stored in the data store 1030. If the user is a guest user, the type of access may be configurable by a registered user, such as the registered user that requested access for the guest user. A user's access may be controlled or set according to an administrator-configurable policy.

In some example implementations, the enterprise system 1002 includes a resource management module 1023. The resource management module 1023 may manage access to resources. In some example implementations, the resource management module 1023 restricts access to a resource (e.g., one user per resource at a given time). In some example implementations, multiple users may access a resource concurrently. That is, the resource management module 1023 may allow multiple users to concurrently edit or alter resources, and manages and tracks the users that make edits when multiple users are editing a document. For example, when one user edits a document, changes that a user makes may be reflected in substantially real-time in the document and thus replicated and/or visible to all other users. If multiple users are editing the document, the changes a user makes may be identified so that other users are aware who made the edits.

In some example implementations, only one user may access a resource in a non-read-only mode. In some example implementations, the resource management module 1023 tracks (e.g., stores) users that access a resource, when a resource is accessed, and any changes made to a resource. This information may be stored in the resource data 1034 of the data store 1030. The resource data 1034 may include the resources themselves and/or information regarding the resources such as access history, information regarding changes to the resources, and the like.

The enterprise system 1002, in some example implementations, includes a notification service 1024 that provides notifications to users. Notification may be transmitted to an account associated with a user, such as through a user via email, text message, automated phone calls/messages, or other similar means.

The notification service 1024 may transmit a notification to a system administrator indicating that the system received the request from a user to authorize a user for guest access to the system. The system administrator may be notified anytime someone tries to give any visitor access to the system. A user may receive a notification when their request to provide access to a guest user is approved and/or when their guest accesses a resource. In some example implementations, a user may receive a notification when a guest attempts to access a resource to which they do not have permission to access.

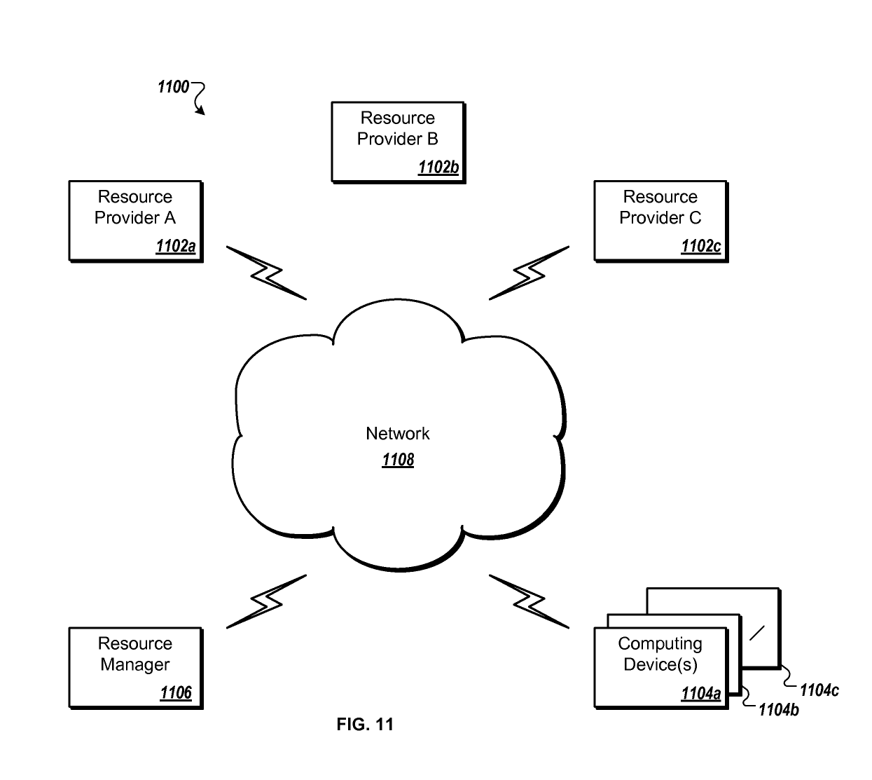

FIG. 11 illustrates an implementation of a network environment 1100 for use in a system implementing a business workflow model. In brief overview, referring now to FIG. 11, a block diagram of an exemplary cloud computing environment 1100 is shown and described. The cloud computing environment 1100 may include one or more resource providers 1102a, 1102b, 1102c (collectively, 1102). Each resource provider 1102 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 1102 may be connected to any other resource provider 1102 in the cloud computing environment 1100. In some implementations, the resource providers 1102 may be connected over a computer network 1108. Each resource provider 1102 may be connected to one or more computing device 1104a, 1104b, 1104c (collectively, 1104), over the computer network 1108.

The cloud computing environment 1100 may include a resource manager 1106. The resource manager 1106 may be connected to the resource providers 1102 and the computing devices 1104 over the computer network 1108. In some implementations, the resource manager 1106 may facilitate the provision of computing resources by one or more resource providers 1102 to one or more computing devices 1104. The resource manager 1106 may receive a request for a computing resource from a particular computing device 1104. The resource manager 1106 may identify one or more resource providers 1102 capable of providing the computing resource requested by the computing device 1104. The resource manager 1106 may select a resource provider 1102 to provide the computing resource. The resource manager 1106 may facilitate a connection between the resource provider 1102 and a particular computing device 1104. In some implementations, the resource manager 1106 may establish a connection between a particular resource provider 1102 and a particular computing device 1104. In some implementations, the resource manager 1106 may redirect a particular computing device 1104 to a particular resource provider 1102 with the requested computing resource.

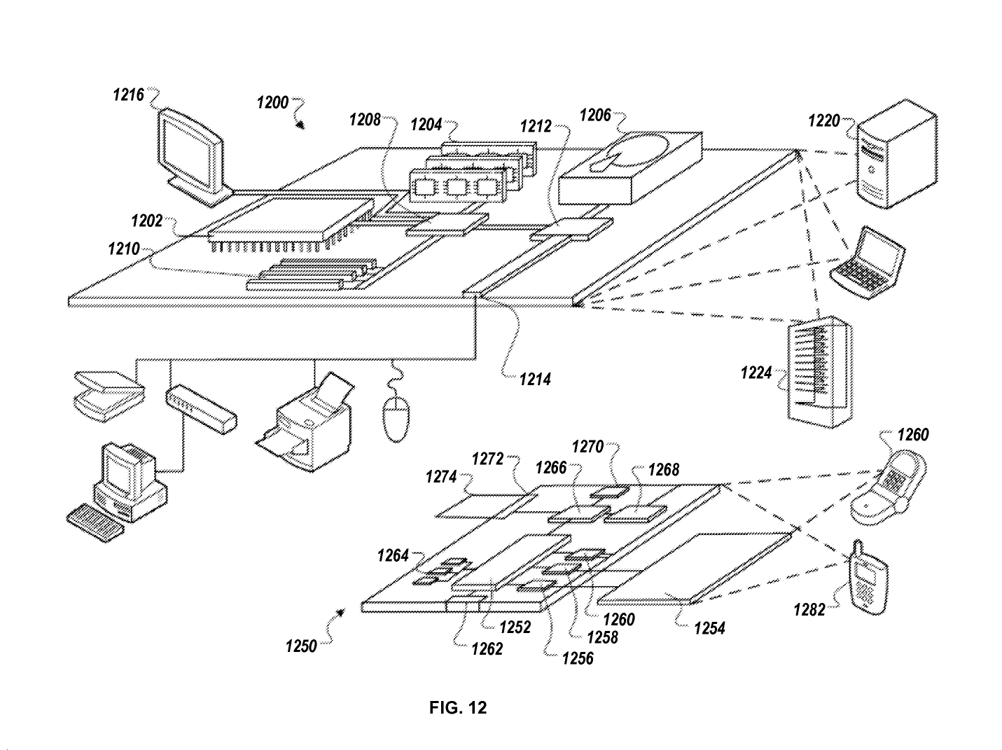

FIG. 12 shows an example of a computing device 1200 and a mobile computing device 1250 that can be used to implement the techniques described in this disclosure. The computing device 1200 is intended to represent various forms of digital computers, such as laptops, desktops, workstations, personal digital assistants, servers, blade servers, mainframes, and other appropriate computers. The mobile computing device 1250 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 1200 includes a processor 1202, a memory 1204, a storage device 1206, a high-speed interface 1208 connecting to the memory 1204 and multiple high-speed expansion ports 1210, and a low-speed interface 1212 connecting to a low-speed expansion port 1214 and the storage device 1206. Each of the processor 1202, the memory 1204, the storage device 1206, the high-speed interface 1208, the high-speed expansion ports 1210, and the low-speed interface 1212, are interconnected using various busses, and may be mounted on a common motherboard or in other manners as appropriate. The processor 1202 can process instructions for execution within the computing device 1200, including instructions stored in the memory 1204 or on the storage device 1206 to display graphical information for a GUI on an external input/output device, such as a display 1216 coupled to the high-speed interface 1208. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 1204 stores information within the computing device 1200. In some implementations, the memory 1204 is a volatile memory unit or units. In some implementations, the memory 1204 is a non-volatile memory unit or units. The memory 1204 may also be another form of computer-readable medium, such as a magnetic or optical disk.

The storage device 1206 is capable of providing mass storage for the computing device 1200. In some implementations, the storage device 1206 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 1202), perform one or more methods, such as those described above. The instructions can also be stored by one or more storage devices such as computer- or machine-readable mediums (for example, the memory 1204, the storage device 1206, or memory on the processor 1202).

The high-speed interface 1208 manages bandwidth-intensive operations for the computing device 1200, while the low-speed interface 1212 manages lower bandwidth-intensive operations. Such allocation of functions is an example only. In some implementations, the high-speed interface 1208 is coupled to the memory 1204, the display 1216 (e.g., through a graphics processor or accelerator), and to the high-speed expansion ports 1210, which may accept various expansion cards (not shown). In the implementation, the low-speed interface 1212 is coupled to the storage device 1206 and the low-speed expansion port 1214. The low-speed expansion port 1214, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 1200 may be implemented in a number of different forms, as shown in the figure. For example, it may be implemented as a standard server 1220, or multiple times in a group of such servers. In addition, it may be implemented in a personal computer such as a laptop computer 1222. It may also be implemented as part of a rack server system 1224. Alternatively, components from the computing device 1200 may be combined with other components in a mobile device (not shown), such as a mobile computing device 1250. Each of such devices may contain one or more of the computing device 1200 and the mobile computing device 1250, and an entire system may be made up of multiple computing devices communicating with each other.

The mobile computing device 1250 includes a processor 1252, a memory 1264, an input/output device such as a display 1254, a communication interface 1266, and a transceiver 1268, among other components. The mobile computing device 1250 may also be provided with a storage device, such as a micro-drive or other device, to provide additional storage. Each of the processor 1252, the memory 1264, the display 1254, the communication interface 1266, and the transceiver 1268, are interconnected using various buses, and several of the components may be mounted on a common motherboard or in other manners as appropriate.

The processor 1252 can execute instructions within the mobile computing device 1250, including instructions stored in the memory 1264. The processor 1252 may be implemented as a chipset of chips that include separate and multiple analog and digital processors. The processor 1252 may provide, for example, for coordination of the other components of the mobile computing device 1250, such as control of user interfaces, applications run by the mobile computing device 1250, and wireless communication by the mobile computing device 1250.

The processor 1252 may communicate with a user through a control interface 1258 and a display interface 1256 coupled to the display 1254. The display 1254 may be, for example, a TFT (Thin-Film-Transistor Liquid Crystal Display) display or an OLED (Organic Light Emitting Diode) display, or other appropriate display technology. The display interface 1256 may comprise appropriate circuitry for driving the display 1254 to present graphical and other information to a user. The control interface 1258 may receive commands from a user and convert them for submission to the processor 1252. In addition, an external interface 1262 may provide communication with the processor 1252, so as to enable near area communication of the mobile computing device 1250 with other devices. The external interface 1262 may provide, for example, for wired communication in some implementations, or for wireless communication in other implementations, and multiple interfaces may also be used.

The memory 1264 stores information within the mobile computing device 1250. The memory 1264 can be implemented as one or more of a computer-readable medium or media, a volatile memory unit or units, or a non-volatile memory unit or units. An expansion memory 1274 may also be provided and connected to the mobile computing device 1250 through an expansion interface 1272, which may include, for example, a SIMM (Single In Line Memory Module) card interface. The expansion memory 1274 may provide extra storage space for the mobile computing device 1250, or may also store applications or other information for the mobile computing device 1250. Specifically, the expansion memory 1274 may include instructions to carry out or supplement the processes described above, and may include secure information also. Thus, for example, the expansion memory 1274 may be provided as a security module for the mobile computing device 1250, and may be programmed with instructions that permit secure use of the mobile computing device 1250. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier and, when executed by one or more processing devices (for example, processor 1252), perform one or more methods, such as those described above. The instructions can also be stored by one or more storage devices, such as one or more computer- or machine-readable mediums (for example, the memory 1264, the expansion memory 1274, or memory on the processor 1252). In some implementations, the instructions can be received in a propagated signal, for example, over the transceiver 1268 or the external interface 1262.

The mobile computing device 1250 may communicate wirelessly through the communication interface 1266, which may include digital signal processing circuitry where necessary. The communication interface 1266 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA 1200, or GPRS (General Packet Radio Service), among others. Such communication may occur, for example, through the transceiver 1268 using a radio-frequency. In addition, short-range communication may occur, such as using a Bluetooth®, Wi-Fi™, or other such transceiver (not shown). In addition, a GPS (Global Positioning System) receiver module 1270 may provide additional navigation- and location-related wireless data to the mobile computing device 1250, which may be used as appropriate by applications running on the mobile computing device 1250.

The mobile computing device 1250 may also communicate audibly using an audio codec 1260, which may receive spoken information from a user and convert it to usable digital information. The audio codec 1260 may likewise generate audible sound for a user, such as through a speaker, e.g., in a handset of the mobile computing device 1250. Such sound may include sound from voice telephone calls, may include recorded sound (e.g., voice messages, music files, etc.) and may also include sound generated by applications operating on the mobile computing device 1250.

The mobile computing device 1250 may be implemented in a number of different forms, as shown in the figure. For example, it may be implemented as a cellular telephone 1280. It may also be implemented as part of a smart-phone 1282, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In view of the structure, functions and apparatus of the systems and methods described here, in some implementations, a system and method for creating and updating a business workflow model (contextual graph) for an enterprise are provided. Having described certain implementations of methods and apparatus for supporting a business workflow model, it will now become apparent to one of skill in the art that other implementations incorporating the concepts of the disclosure may be used. Therefore, the disclosure should not be limited to certain implementations, but rather should be limited only by the spirit and scope of the following claims.

Throughout the description, where apparatus and systems are described as having, including, or comprising specific components, or where processes and methods are described as having, including, or comprising specific steps, it is contemplated that, additionally, there are apparatus, and systems of the disclosed technology that consist essentially of, or consist of, the recited components, and that there are processes and methods according to the disclosed technology that consist essentially of, or consist of, the recited processing steps.

It should be understood that the order of steps or order for performing certain action is immaterial so long as the disclosed technology remains operable. Moreover, two or more steps or actions may be conducted simultaneously. Similarly, one or more modules may be combined into a single module and a single module as described may be separated into multiple modules. Moreover, it should be understood that the systems and methods implemented by a processor. When multiple processors are used, the processors may be located remotely from each other and communicate over a network.

Having described various embodiments of the disclose technology, it will now become apparent to one of skill in the art that other embodiments incorporating the concepts may be used. It is felt, therefore, that these embodiments should not be limited to the disclosed embodiments, but rather should be limited only by the spirit and scope of the following claims. Headers are provided for context and are not intended to be limiting.

1-21. (canceled)

22. A system for managing contextual collaborations, comprising:
a memory operable to store user data corresponding to a plurality of users, the plurality of users including at least a first user and a second user, and
a processor coupled to the memory, the processor being operable to:
receive, from a first computing device associated with the first user, a first access-level designation for a first document included in a first contextual collaboration;
store the first access-level designation in association with the first user and the first document;
receive, from a second computing device associated with a second user, a request to access the first document included in the first contextual collaboration;
determine, based on the first access-level designation stored in association with the first document, whether to provide access to the first document by the second computing device associated with the second user; and
transmitting a response to the second computing device associated with the second user, the response granting or denying access to the first document.

23. The system of claim 22, wherein the first user is an owner of the first document.

24. The system of claim 22, wherein the access-level designation of the first document selected, via the first computing device, from a list of predefined sets of access level designations.

25. The system of claim 22, wherein the first access-level designation is caused to be displayed at computing devices corresponding to the plurality of users.

26. The system of claim 22, wherein the first access-level designation is selected from a set of access-level designations.

27. The system of claim 26, wherein the set of access-level designations includes a first user-access designation, a second user-access designation, a third user-access designation and a fourth user-access designation, wherein
the first user-access designation grants access to a document by one or more owners of a document and one or more designated users of the document,
the second user-access designation grants access to a document by a one or more owners of the document and one or more domain users of the document,
the third user-access designation grants access to a document by a one or more owners of the document and one or more domain users of the document, if the one or more owners of the document and/or one or more domain users of the document are subject to an agreement, and
the fourth user-access designation grants access to one or more users that are subject to an agreement.

28. The system of claim 27, wherein
the one or more designated users are users that have been granted access to the document, and
the one or more domain users are users associated with a predetermined domain.

29. The system of claim 28, wherein the one or more domain users are identified using their corresponding user data, including a user domain associated with the user data of each of the plurality of users.

30. The system of claim 28, wherein the process is operable to:
transmit a prompt to the first user requesting confirmation of whether at least one of the plurality of users is subject to an agreement.

31. The system of claim 22, wherein
the first user, the second user and a third user are associated with a first enterprise and with the first contextual collaboration, and
the processor is operable to:
receive, from a third computing device associated with the third user, a request to access the first document included in the first contextual collaboration; and
transmit, to the third computing device associated with the third user, a response including a refusal of access to the first document.
